(19) United States
(12) Patent Application Publication
(10) Pub. No.: US 2005/0234831 A1
(43) Pub. Date: Oct. 20, 2005

(54) Automatic monitoring method and apparatus for fetching available quantities of electronic data

(76) Inventor: Norbert Stangl Herrn, Boppard (DE)

Correspondence Address: SUTHERLAND ASBILL & BRENNAN LLP, 999 PEACHTREE STREET, N.E., ATLANTA, GA, 30309, US

(21) Appl. No.: 10/935,923

(22) Filed: Sep. 8, 2004

(30) Foreign Application Priority Data
Sep. 9, 2003 (DE) 103 41 894.6

(51) Int. Cl. G06F 17/60

(52) U.S. Cl. 705/52

(57) ABSTRACT

The invention relates to a method of and an apparatus for automatically monitoring and automatically accounting the fetching of a quantity of electronic data available from a data base (4), especially a data base on the internet, through a first online connection (5; 5′) between a user computer (1) and the data base (4). A bank server means (7) is involved in the automatic checking of the access authorization of a user to fetch the quantity of data available from the data base (4), which bank server means (7) is connected through an online connection (8) to the server means (3) to which the user addresses his/her request by mans of the user computer (1).

The invention relates to the art of automatically monitoring and automatically accounting the fetching of a quantity of electronic data available from a data base, especially a data base on the internet.

Providers of contents, i.e. quantities of electronic data in the form of text, image and/or sound data to be fetched by users from the internet increasingly tend to no longer offer such contents free of charge but against payment of a fee. For example, publishers of newspapers or journals offer electronic archives of the articles published in print in their journals or newspapers. The user is charged with a fee for the fetching, i.e. electronic downloading from the archive to a user computer utilized by the user, for instance, to print the article by means of a printer connected to the user computer. The fee can be calculated also in dependence on the amount of data fetched. Consumer information is another example of providing electronic data to be called up against payment of a fee. Various methods exist of correctly recording the amount of electronic data fetched and of generating the respective electronic cost/fee information for the accounting. One such method is described in document EP 1 332 438 A1, for example.

To assure that a correct procedure is followed when automatically accounting the fetching of quantities of electronic data, especially from the internet, it is required among others that the authorization of users accessing the quantities of electronic data available be checked automatically and efficiently within as little time as possible. This is part of user friendly service. Automatic accounting of the quantities of electronic data fetched is accomplished usually by an exchange of electronic information when checking the access authorization. Such information in particular relates to the kind of payment desired, such as by credit card or debiting of a bank account. And the exchange takes place between the user computer utilized by the user and a server means which, executes the procedure of checking the access authorization. The data exchanged on this occasion partly are subject to security requirements and, therefore, involve quite considerable technical expenditure to meet the safety regulations for electronic data exchange.

It is, therefore, an object of the invention to provide an improved method and an improved apparatus for automatically monitoring and automatically accounting the fetching of a quantity of electronic data available from a data base, both reducing the expenditure to guarantee that electronic data are exchanged securely and, therefore, at lower cost. It is another object of the invention to optimize the handling comfort for the user.

These objects are met by a method as defined in independent claim 1 and an apparatus as defined in independent claim 4, respectively.

According to an aspect of the invention a method is provided of automatically monitoring and automatically accounting the fetching of a quantity of electronic data available from a data base, especially a data base on the internet, through a first online connection between a user computer and the data base, the method comprising the following steps:
checking a user's access authorization to fetch the quantity of electronic data available from the data base, in that
   a user input made through the user computer is recorded by a server means connected to the user computer through a second online connection, the user input recorded comprising electronic data of a user name, a banking institution, and a bank account;
   the user input recorded is analysed electronically by the server means, and a third online connection is established between the user computer and a bank server means, the bank server means being selected automatically in the server means in response to the result of the electronic analysis of the user input recorded, especially the electronic information on the banking institution and/or the bank account, by at electronic comparison of the result of the electronic analysis of the user input recorded and stored electronic data, and online account transactions relating to the bank account being executable through the bank server means by way of a home banking application;
   electronic analysis data of the user input recorded and analysed are transmitted through a fourth online connection from the server means to the bank server means;
   a usage authorization of the user to conduct the online account transactions is verified by the bank server means, another user input through the user computer being recorded and analysed electronically by the bank server means, and the other user input including a user identification; and
   upon verification of the usage authorization of the user to conduct online account transactions, electronic status information is transmitted through the fourth online connection from the bank server means to the server means;
generating and storing electronic registration data by the server means if it is determined, in evaluating the electronic status information in the server means, that the usage authorization of the user to conduct the online account transactions was found upon verification; releasing the fetching of the quantity of electronic data available from the data base through the first online connection between the user computer and the data base; and automatically recording the fetching of the quantity of electronic data made available through the first online connection and generating corresponding electronic accounting information to cover the fetching of the quantity of electronic data made available.

According to another aspect of the invention an apparatus is provided for automatically monitoring and automatically accounting the fetching of a quantity of electronic data available from a data base, especially a data base on the internet, through a first online connection between a user computer and the data base, as recited in independent claim 4.

The invention embraces the concept of incorporating a bank server means in the checking and registration of a user's access authorization, often also referred to as authentication of the user, for the fetching of quantities of electronic data available as well as their automatic accounting. This bank server means can be utilized by the user to carry out online account transactions in a home banking application. Due to security technology regulations, such a bank server means is furnished with the necessary technical equipment for electronic exchange of security sensitive data in connection with online account transactions. This means that the electronic data exchange between the user computer and the bank server means can be effected in agreement with defined security regulations. When it comes to checking the access authorization of the user to fetch quantities of electronic data available from the data base, the server means, first recording a user input made by the user through the user computer, takes recourse to the bank server means to authenticate the user who is making the request. In the process, the given technical equipment of the bank server means may be utilized for electronically exchanging security sensitive data with the user computer. Thus the expenditure required for the technical implementation to meet the safety provisions which regulate electronic data exchange between the user computer and the server means can be reduced to the extent that the exchange of security sensitive data is shifted into the bank server means. In this manner only the bank server means is subject to the continual maintenance and updating of measures required to assure that the safety standard is met. And the bank server means is at the disposal both for the customary homebanking transactions and for use in checking the access authorization when the quantities of electronic data available are fetched from the data base. The term data base, as used here, includes any desired source which can render quantities of electronic data ready to be called, in particular data bases in the conventional sense, server means, electronic archives, and the like.

The invention, furthermore, helps to improve the handling comfort for users. As the bank server means already has at its disposal in electronic form the necessary data required for home banking applications, these may be utilized automatically when checking the user's access authorization to fetch the electronic data available.

As the user need not enter them once more through the user computer, less time is spent by the user.

The safety standard may be enhanced even more in accordance with a further development of the invention according to which al; least the electronic data involved in the data exchange through the fourth online connection between the server means and the bank server means are exchanged in encrypted form.

Further increase in efficiency due to utilization of electronic data already given is obtained with a convenient modification of the invention in that the associated electronic accounting information is transmitted to the bank server means, and the bank server means automatically causes electronic debiting of the bank account in accordance with the associated accounting information.

The invention will be described further, by way of example, with reference to the accompanying drawing, in which:

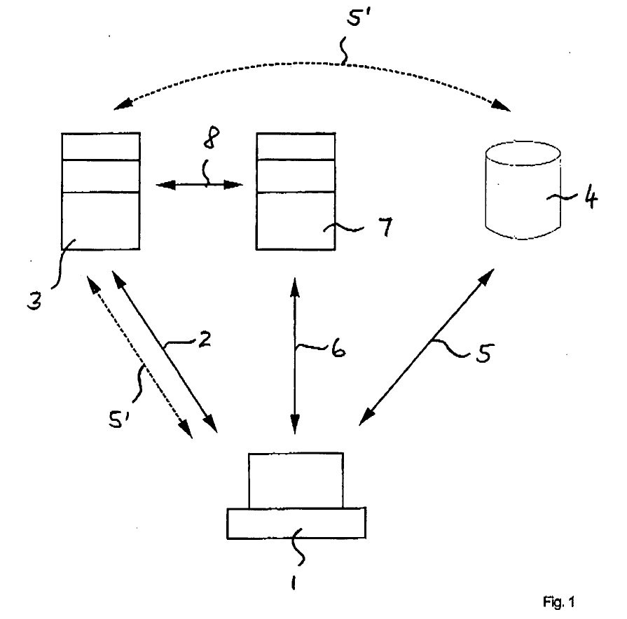

FIG. 1 is a diagrammatic illustration of an apparatus for automatic monitoring and automatic accounting of the fetching of a quantity of electronic data available from a data base;

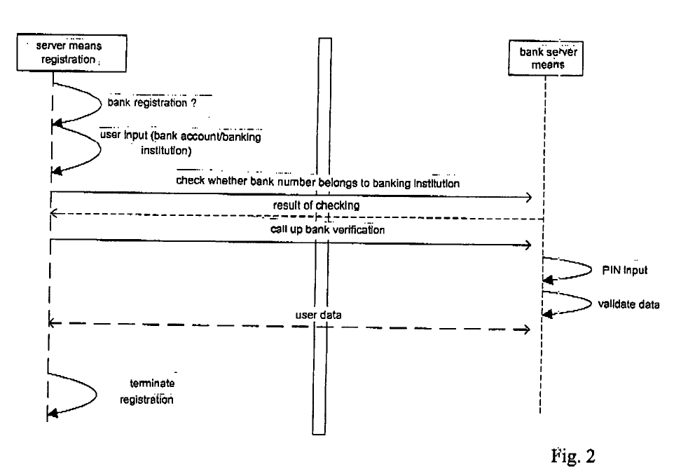

FIG. 2 is a diagrammatic illustration for explaining a method when use is made of the apparatus shown in FIG. 1; and

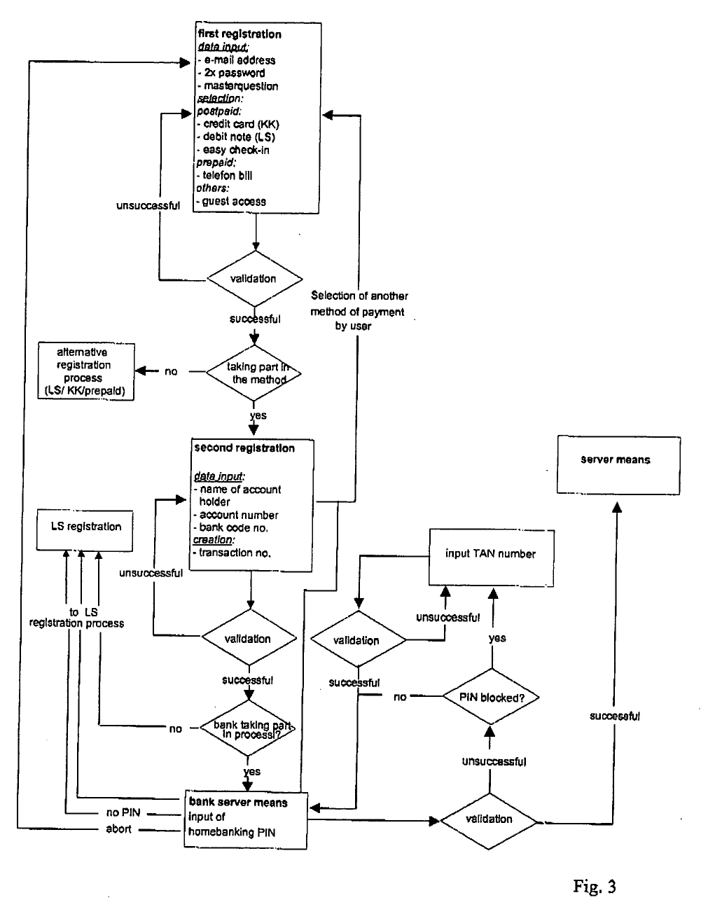

FIG. 3 is a flowchart when automatically monitoring and automatically accounting the fetching of a quantity of electronic data available from a data base.

Referring to FIGS. 1 to 3, a method will be described of automatically monitoring and automatically accounting the fetching of a quantity of electronic data available from a data base, especially a database on the internet, accounting, for instance, in response to the quantity of data fetched. While FIG. 1 is a diagrammatic presentation of an apparatus for carrying out the method, FIG. 2 gives an overview of the steps taken with the method which are shown in greater detail in FIG. 3.

As may be taken from FIG. 1, a user computer 1 is connected through an online connection 2 to a server means 3 for exchanging electronic data. A suitable operating system executing a software implemented application is installed in the server means 3, especially for checking an access authorization and/or registration of a user to fetch quantities of electronic data available from a data base 4. The data base 4 is any desired source holding quantities oaf electronic data ready to be fetched, for example, a data base in the conventional sense, a server means, an electronic archive, or the like. When a user wishes to fetch quantities of electronic data from the data base 4 by means of the user computer 1, in other words wishing to download them for the first time through an online connection 5 by actuating the user computer 1, at first, user inputs made by the user through the user computer 1, for example, via a keyboard or as speech entries, will be recorded electronically by the server means 3. The user input recorded by the server means 3 includes electronic data in respect of the user name, a banking institution, and a bank account. To poll these data from the user, the server means 3 generates a suitable input mask which is transmitted to the user computer 1 through the online connection 2.

The server means 3 then establishes an online connection 6 between the user computer 1 and a bank server means 7 in response to the electronic data in respect of the banking institution and the bank account included in the user input recorded. The server means 3, moreover, transmits the electronic data on the user name, the banking institution, and the bank account to the bank server means 7 through an online connection 8 between the server means 3 and the bank server means 7. The user computer 1 is connected by the online connection 6 to the bank server means 7 in such a way that further user inputs can be requested from the user of the user computer 1 by means of a suitable input mask. Such further inputs especially may be an identification number (PIN) which will allow the bank server means 7, upon electronic evaluation of the further user input, to verify the authorization of the user to conduct an account transaction regarding the bank account within an online b&-king application implemented by the bank server means 7. Various banking institutions nowadays offer such online banking applications for their respective customers, usually requiring that special security provisions be observed in the electronic data exchange in connection with banking applications.

The scope of the further user input requested by the bank server means 7 may vary depending on the particular application. However, the user input always must be sufficient for the authorization of the user to be checked. If it is found, in verifying the authorization with the assistance of the bank server means 7, that the user indeed is authorized, the bank server means 7 will generate status information and transmit it through the online connection 8 to the server means 3. The status information informs the server means 3 that the user who addressed the server means 3 with the request to fetch quantities of electronic data from the delta base 4 has been authenticated. The status information may include electronic data in respect of the bank account so that later on the server means 3 can allocate the fetching of quantities of electronic data from the data base 4 to the bank account.

When the user has been authenticated by resorting to the bank server means 7 additional registration measures may be taken through the server means 3, such as requests for additional information. Upon completion of the registration, registration data are generated in the server means 3 and stored electronically. Following that, the user is entitled to fetch quantities of electronic data from the data base 4 through the online connection 5, against payment. In FIG. 1 a direct online connection 5 is indicated between the user computer 1 and the data base 4. Yet the fetching of quantities of electronic data against payment from the data base 4 to the user computer 1 also may take a detour, for example, through further server means on the internet (not shown in FIG. 1), including the server means 3, as indicated diagrammatically in FIG. 1 by the online connection 5′.

During the fetching, the server means 3 watches to what extent quantities of electronic data are called from the data base 4. Based on this information, the server means 3 generates corresponding electronic accounting information. This respective electronic accounting information then may be utilized to transmit electronic debiting information through the online connection 8 to the bank server means 7. The bank server means 7 thus will cause electronic debiting of the account in response to the electronic accounting information received. Therefore, an efficient process on the whole is achieved for implementing the steps comprised by the fetching against payment of quantities of electronic data from the data base 4. In this context, those skilled in the art may make use of any desired method of recording the scope of the quantities of electronic data fetched and subsequently calculating the costs thereof. The use of the particular method may be combined with the process of checking the user's access authorization, incorporating the bank server means 7 in the process.

Moreover, the method described above is independent of the particular method by which the costs ultimately are billed that are calculated when recording the quantity of electronic data fetched. Accounting by way of a credit card also may be provided at the end of the recording of the costs.

The features of the invention disclosed in the specification above, in the claims, and drawing may be significant for implementing the invention in its various embodiments, both individually and in an combination.

1. A method of automatically monitoring and automatically accounting the fetching of a quantity of electronic data available from a data base, especially a data base on the internet, through a first online connection between a user computer and the data base, the method comprising the following steps:
checking a user's access authorization to fetch the quantity of electronic data available from the data base, in that
a user input made through the user computer is recorded by a server means connected to the user computer through a second online connection, the user input recorded comprising electronic data of a user name, a banking institution, and a bank account;
the user input recorded is analysed electronically by the server means, and a third online connection is established between the user computer and a bank server means, the bank server means being selected automatically in the server means in response to the result of the electronic analysis of the user input recorded, especially the electronic information on the banking institution and/or the bank account, by an electronic comparison of the result of the electronic analysis of the user input recorded and stored electronic data, and online account transactions relating to the bank account being executable through the bank server means by way of a home banking application;
electronic analysis data of the user input recorded and analysed are transmitted through a fourth online connection from the server means to the bank server means;
a usage authorization of the user to conduct the online account transactions is verified by the bank server means, another user input through the user computer (1) being recorded and analysed electronically by the bank server means, and the other user input including a user identification; and
upon verification of the usage authorization of the user to conduct online account transactions, electronic status information is transmitted through the fourth online connection from the bank server means to the server means;
generating and storing electronic registration data by the server means if it is determined, in evaluating the electronic status information in the server means, that the usage authorization of the user to conduct the online account transactions was found upon verification;
releasing the fetching of the quantity of electronic data available from the data base through the first online connection between the user computer and the data base; and
automatically recording the fetching of the quantity of electronic data made available through the first online connection and generating corresponding electronic accounting information to cover the fetching of the quantity of electronic data made available.

2. The method as claimed in claim 1, characterized in that at least the electronic data are exchanged using encrypted data when exchanging data through the fourth online connection between the server means and the bank server means.

3. The method as claimed in claim 1, characterized in that the associated electronic accounting information is transmitted to the bank server means, and the bank server means automatically causes electronic debiting of the bank account in accordance with the associated electronic accounting information.

4. An apparatus for automatically monitoring and automatically accounting the fetching of a quantity of electronic data available from a data base, especially a data base on the internet, through a first online connection from the data base to a user computer, the apparatus further comprising the following features:
a server means connected through a second online connection to the user computer and having the following features:
checking means to check a user's access authorization to fetch the quantity of electronic data available from the data base;
recording means to record a user input made through the user computer, the user input recorded comprising electronic data of a user name, a banking institution, and a bank account;
analyzing means to analyse the user input recorded; and
selecting means to automatically select the bank server means in response to the result of the electronic analysis of the user input recorded, especially the electronic information on the banking institution and/or the bank account, by an electronic comparison of the result of the electronic analysis of the user input recorded and stored electronic data; and
a bank server means connected through a third online connection to the user computer and through a fourth online connection to the server means, having the following features:
transaction means to execute online account transactions relating to the bank account by way of a home banking application;
verification means to verify a user authorization of the user for the online account transactions by the bank server means, another user input through the user computer being recorded and analysed electronically by the bank server means, and the other user input including a user identification; and
transmitting means to transmit electronic status information upon verification of the usage authorization of the user to conduct online account transactions through the fourth online connection from the bank server means to the server means;
the server means further comprising the following features:
means for generating and storing electronic registration data if it is determined, in evaluating the electronic status information in the server means, that the usage authorization of the user to conduct the online account transactions was found upon verification;
releasing means to release the fetching of the quantity of electronic data available from the data base through the first online connection between the user computer and the data base; and
monitoring means to automatically record the fetching of the quantity of electronic data made available through the first online connection and generate associated electronic accounting information to cover the fetching of the quantity of electronic data made available.
